(19) United States
(12) Patent Application Publication
(10) Pub. No.: US 2026/0065640 A1
(43) Pub. Date: Mar. 5, 2026

(54) SYSTEMS AND METHODS FOR UTILIZING LOW-RESOURCE TRAINING DATASETS FOR SPACE-BASED OBJECT DETECTION

(71) Applicant: Booz Allen Hamilton Inc., McLean, VA (US)

(72) Inventors: Bruce Andrew JOHNSON, Marana, AZ (US); Zackary Ryan WERNER, El Segundo, CA (US); Derek Paul DAY, JR., Colorado Springs, CO (US)

(73) Assignee: Booz Allen Hamilton Inc., McLean, VA (US)

(21) Appl. No.: 18/819,376

(22) Filed: Aug. 29, 2024

(51) Int. Cl. G06V 10/764; G06V 10/20; G06V 10/75

(52) U.S. Cl. CPC G06V 10/764; G06V 10/255; G06V 10/751

(57) ABSTRACT

Embodiments can relate to a system for efficiently and dynamically classifying an object of an input image. The system can include an input module for receiving an image of an area of interest captured by an image capture device. The system can include a memory including a synthetic dataset composed of templates, wherein at least one template can be constructed of a statistical mean of shapes. The system can include a processor having a detection module and a classifier module. The detection module can be configured to scan an image to identify a streak pattern. The classifier module can be configured to compare a streak pattern to classify a streak pattern as being representative of a resident space object or representative of a star. The system can include a user interface configured to generate an output identifying a streak pattern as a resident space object or a star.

### FIELD

Embodiments can relate to efficiently and dynamically classifying an object of an input image.

### BACKGROUND INFORMATION

Detecting and classifying resident space objects (RSOs) in low Earth orbit (LEO) can be a difficult task. This difficulty can be exacerbated when attempting to classify RSOs using classifier models (e.g., neural network-based detector/classifiers). One reason for this difficultly can be the lack of curated and labeled training data necessary for a neural network-based object detector/classifier. Another reason can be that the objects to be detected and classified are generally small, rare, and irregularly shaped.

### SUMMARY

An exemplary can relate to a system for efficiently and dynamically classifying an object of an input image. The system can include an input module for receiving an image of an area of interest captured by an image capture device. The system can include a memory including a synthetic dataset composed of templates. One or more templates can be constructed of a statistical mean of shapes. The system can include a processor. The processor can include a detection module and a classifier module. The detection module can be configured to scan an image to identify a streak pattern. The classifier module can be configured to compare a streak pattern from the detection module and access one or more templates from the memory to classify a streak pattern as being representative of a resident space object or representative of a star. The system can include a user interface configured to generate an output identifying a streak pattern as a resident space object or a star.

An exemplary embodiment can relate to a method for efficiently and dynamically classifying an object of an input image. The method can involve receiving an image of an area of interest captured by an image capture device. The method can involve scanning an image to identify a streak pattern. The method can involve comparing a streak pattern to one or more templates of a synthetic dataset to classify a streak pattern as being representative of a resident space object or representative of a star. The synthetic dataset can be composed of templates. At least one template can be constructed of a statistical mean of shapes. The method can involve generating an output identifying a streak pattern as a resident space object or a star.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1 shows an exemplary system diagram;

FIG. 2 shows an exemplary flow diagram for generating labeled images;

FIG. 3 shows a typical RSO-containing image;

FIG. 4 shows an exemplary outcome of applying ESA to the image of FIG. 3;

FIG. 5 shows an exemplary results of synthetic dataset generation; and

FIG. 6 shows an exemplary flow diagram for generating a synthetic training image.

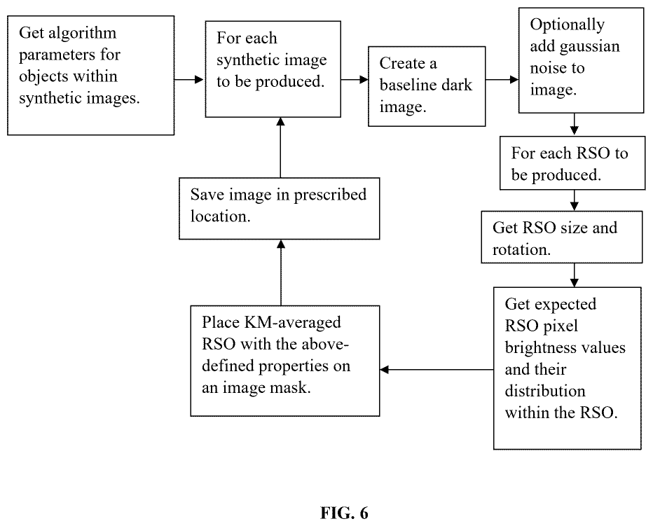

### DETAILED DESCRIPTION

Low earth orbit contains several RSO's. RSOs can be satellites, space junk, etc., each having a vastly different sizes, shapes, trajectories, etc. from another. RSOs tend to be difficult to detect based on an image of them. This is because images of RSOs tend to include streaks, or the RSOs themselves merely appear as streaks in the image. Streaks in images of RSOs can be caused by the RSOs passing through a sensor's field of view while the image is being captured. Due to this phenomenon, streak detection is a common technique used in space surveillance to identify RSOs that are too faint or fast-moving to see easily. The streak detection process generally involves recognizing the streaks in images and associating them with RSOs. For instance, an image of a streak can be analyzed to determine whether the streak represents an RSO, a star, etc. This type of detection can be helpful for situations in which it is desired to know if a satellite's trajectory about to cause a collision with an RSO, for example.

However, due to irregular shapes of the RSOs and the streaks themselves, it is difficult to use artificial intelligence, algorithmic models, etc. to assist with identification of RSOs. Namely, it is difficult to develop a trained dataset of ground-truthed images, because it is impractical, if not impossible, to develop ground-truthed images for such a purpose. Embodiments disclosed herein, however, provide a means to generate a ground-truthed data set with little to no actual ground-truthed imagery. In fact, embodiments disclosed herein can generate a trained dataset of synthetic data based merely on a notion of what an object (e.g., RSO) or a streak is expected to look like. With the synthetic data set, templates constructed of a statistical mean of shapes can be generated and used by a classifier module 108 (e.g., a neural net classifier) to classify objects based on the streaks present in an image. For instance, a new image containing streaks can be analyzed using the techniques disclosed herein without having to rely on real or actual ground-truthed data. Instead, the system 100 can accurately and efficiently compare imagery in the new image to the synthetic ground-truthed dataset using the shape analysis techniques disclosed herein. In addition, the system 100, via the templates, can adapt any of the trained data set quickly to adjust for new types of RSOs, streaks, and/or environmental conditions under which the imagery is obtained.

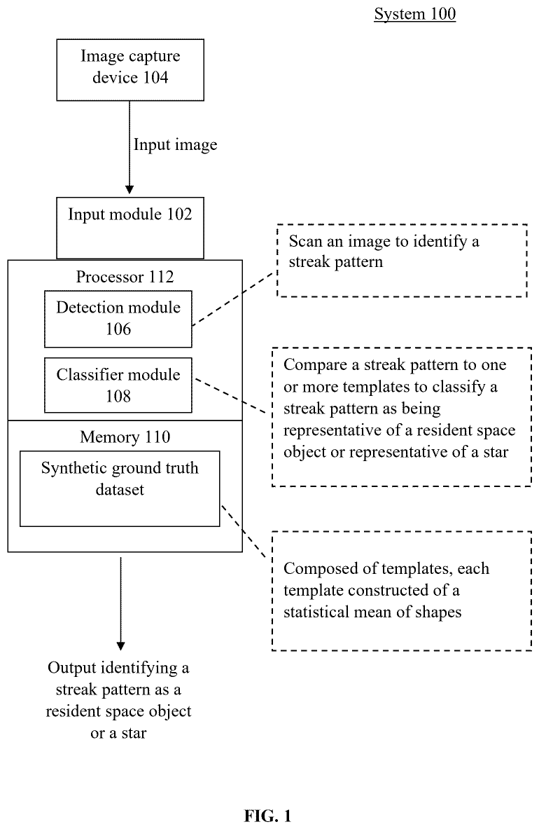

Referring to FIG. 1, embodiments can relate to a system 100 for efficiently and dynamically classifying an object (e.g., RSO) of an input image. The system 100 can include one or more input modules 102. The input module 102 can be configured for receiving an image of an area of interest. This can be an image of an area of interest captured by one or more image capture devices 104, for example. The input module 102 can include or be a processor having program logic stored in memory associated with the processor for facilitating customization of data pertaining to an event, management of communication between an event capturing apparatus (e.g., an image capture device 104), management of power loads, etc. The input module 102 can also include receiver(s), antenna(s), transmitter(s), etc.

The image capture device 104 can be an optical or digital camera, an optical or digital video recorder, a monitor, etc. It is contemplated for the image capture device 104 to be an optical or digital camera, which can be configured as a charge-coupled device, an active-pixel sensor device, etc. The image capture device 104 can include a processor and associate memory configured for capturing, recording, processing, storing, transmitting, etc. images.

As a non-limiting example, a spacecraft (e.g., satellite, space vehicle, rocket, weapon system, etc.) can include an embodiment of the system 100 or be in communication with an embodiment of the system 100. The system 100 can be used to determine whether the trajectory or intended trajectory of the spacecraft is, will, or is predicted to be in the trajectory of an RSO. The system 100 can use the image capture device 104 to capture an image of an area of interest (e.g., an area that includes the trajectory or intended trajectory of the spacecraft). The image can be processed by the image capture device 104, stored in memory for later processing, and/or sent to the input module 102. As will be explained herein, the system 100 can also include a detection module 106 configured to scan an image (e.g., an image from the image capture device 104) to identify a streak pattern. The system 100 can also include a classifier module 108 configured to classify the streak pattern as being representative of a RSO, representative of a star, etc. If the streak pattern is determined to be representative of a RSO, then there might be a concern that the trajectory of the spacecraft would intersect the trajectory of the RSO. If the streak pattern is determined to be representative of a star, then it can be concluded that there is little to no likelihood of a spacecraft-RSO trajectory intersection. The above scenario is only one example of how the system 100 can be used.

The system 100 can include one or more memories 110. The memory 110 can including one or more synthetic datasets. The synthetic dataset can be composed of one or more templates (e.g., data structure(s) or format(s) configured to organize and present data with consistency). Any of the templates can be constructed of a statistical mean of shapes. The statistical mean of shapes can include actual and/or expected shapes that conform to an item of interest. An item of interest can be a RSO, a star, etc. For instance, streaks of RSOs can have recognizable or known patterns that have been documented. A template can be constructed of one or more statistical means of actual streak shapes and/or expected streak shapes. Actual streak shapes can be streak shapes that have been collected and documented as being representative of RSOs, starts, etc. Expected streak shapes can be notion(s) of what constitute(s) an item of interest. With a statistical mean of expected streak shapes, a synthetic dataset can be composed of ground-truthed data that has little to no actual streak shape data.

The statistical mean can be a geometric mean (e.g., a Karcher mean), a harmonic mean, root mean square mean, etc. It is contemplated for the statistical mean to be a Karcher mean. For instance, the statistical mean can be a geometric mean of several matrices of data points representative of plural actual shapes and/or expected shapes.

The system 100 can include one or more processors 112. The processor can be any of the processors disclosed herein. The processor can be part of or in communication with a machine (logic, one or more components, circuits (e.g., modules), or mechanisms). The processor can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence programming, automated reasoning programming, etc. Use of processors herein can include any one or combination of a Graphics Processing Unit (GPU), a Field Programmable Gate Array (FPGA), a Central Processing Unit (CPU), etc. The processor can include one or more processing modules. A processing module can be a software or firmware operating module configured to implement any of the method steps disclosed herein. The processing module can be embodied as software and stored in memory, the memory being operatively associated with the processor. A processing module can be embodied as a web application, a desktop application, a console application, etc.

The processor can include or be associated with a computer or machine readable medium. The computer or machine readable medium can include memory. The computer or machine readable medium can be configured to store one or more instructions thereon. The instructions can be in the form of algorithms, program logic, a model, etc. that cause the processor to perform any of the functions described herein.

Any of the memory discussed herein can be computer readable memory configured to store data. The memory can include a volatile or non-volatile, transitory or non-transitory memory, and be embodied as an in-memory, an active memory, a cloud memory, etc.

Embodiments of the memory can include a processor module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc.

The processor can be in communication with other processors of other devices (e.g., a computer device, a desktop computer, a laptop computer, a computer system, etc.). Any of those other devices can include any of the exemplary processors disclosed herein. Any of the processors can have transceivers or other communication devices/circuitry to facilitate transmission and reception of wireless signals. Any of the processors can include an Application Programming Interface (API) as a software intermediary that allows two applications to talk to each other. Use of an API can allow software of the processor of the system to communicate with software of the processor of the other device(s), if the processor of the system is not the same processor of the device.

Any data transmission between the processor and memory, between the processor and a database, and between the processor and processors of other devices, etc. can be via a pull operation (e.g., the processor can pull the data) or a push operation (e.g., the data can be pushed to the processor). The processor can receive the data in steaming format, or store it in memory before being processed. In addition, embodiments of the algorithm, model, etc. disclosed herein can be developed as an application software (an “App”) to be implemented on a processor of a device. The App can be sent via a steaming format, or the App can be sent and stored on a memory associated with or accessed by the device.

As noted herein, the processor can be configured to be a component of, used in combination with, or in communication with another device/system—e.g., this can include the processor being part of the device/system, the device/system being part of the processor, the processor in communication with the device/system, etc. “Being part of” can include being on a same substrate or integrated circuit. For instance, the processor can be a component of, used in combination with, or in communication with a predictive modeling system, a decision support system, an automated control system, etc. The processor can use the model or algorithm or provide the model or algorithm to the device/system to assist with or augment the performance of these devices/systems.

While exemplary embodiments may describe and/or illustrate one processor and one memory, it is understood that the system can include any number of processors and memories.

The processor 112 can include one or more detection modules 106. The detection module 106 can be configured to scan an image to identify one or more streak patterns. For instance, the detection module 106 can be configured to receive one or more images from the input module 102. The detection module 106 can be programmed to use one or more image processing techniques (e.g., image segmentation, image compression, morphology, object detection, feature extraction, image recognition, pattern recognition, projection, elastic shape analysis, Gabor filtering, liner filtering, etc.) to determine that one or more streaks is present in the image. For instance, the detection module 106 can be configured to identify a streak pattern(s) using a shape analysis technique (e.g., elastic shape analysis). As a non-limiting example, the detection module 106 can be configured to use elastic shape analysis to extract features that define a blob pixel, a streak pixel, etc. of the identified streak(s) in the image.

The processor 112 can include one or more classifier modules 108. The classifier module 108 can be configured to compare one or more streak pattern from the detection module 106 to classify the streak pattern. The classifier module 108 can be a neural net object classifier module, decision tree classifier module, KNN classifier module, logistic regression classifier module, etc. The classifier module 108 can access one or more templates from the memory 110 to classify the streak pattern(s). It can classify it/them as being representative of a RSO, representative of a star, etc. Again, the templates can be composed of statistical means of actual and/or expected shapes. The classifier module 108 can implement one or more classification techniques (e.g., supervised, unsupervised, neural net, decision tree, KNN, logistic regression, naïve bayes, random forest, etc.) an apply it/them to the synthetic dataset. It can do this by applying the classification technique(s) to one or more data structures within the synthetic dataset. For instance, the classifier module 108 can select one or more of the templates to apply the classification technique(s). The classification technique(s) can be applied to the template(s) or data structure(s) within the template(s) in a serial manner, in a parallel manner, in an iterative manner, in a recursive manner, etc.

The synthetic ground truthed dataset can include labeled images of an averaged representation of image classes in which objects from an image had been extracted via a shape analysis technique (e.g., clastic shape analysis). While details of how the synthetic ground truthed dataset can be generated are presented below in the “examples” section of the disclosure, an overview of an exemplary technique for doing so is provided in this paragraph. Labeled images of an averaged representation of image classes can be generated as statistical data from pixels present in the extracted objects that were used to generate an averaged representation of an actual resident space object and/or what constitutes a typical shape of an expected resident space object. With this representation, a distance between a curve of a perimeter of the shape of interest of the object and a curve of a perimeter of a reference shape (e.g., an actual shape and/or an expected shape) can be quantified. A measure of distance between the curve of the perimeter of the shape of interest of the object and the curve of the perimeter of the reference shape can then be determined. A Riemannian metric and a Square Root Velocity function can be used to quantify the distance. A path straightening technique can be used to determine that the shape of interest matches the reference shape. This method can be used to generate a synthetic ground truthed dataset. This synthetic ground truthed dataset can be stored in the memory 110.

With access to this synthetic ground truthed dataset, the classifier module 108 can classify one or more of the streaks of a new image from the image capture device 104. It can efficiency classify the streak(s) as being representative of a RSO, representative of a star, etc. by accessing one or more of the templates of the synthetic ground truthed dataset that have been stored in the memory 110. It can also generate a classification of one or more of the streaks as being representative of a RSO, representative of a star, etc. The classification(s) can be encoded into a signal and stored in memory 110.

The system 100 can include processors, computer devices, displays, etc. configured to generate one or more user interfaces. The user interface can be configured to generate an output. The output can be a textual, audio, visual, graphical, etc. output configured to indicate the classification(s) of the streak pattern(s). For instance, the output can indicate or identify a streak pattern as a RSO, a star, etc. Thus, a display can receive the classification signal from the memory 110 and generate a notification, via the user interface, that is a representation of the classification of the streak(s) identified within the image.

Additional embodiments can relate to a method for efficiently and dynamically classifying an object of an input image. As can be appreciated from the disclosure, the first step can be automatically generating synthetic ground-truthed dataset(s) for training purposes. To begin this process, a limited number of actual space images containing RSOs and streaks can be obtained and labelled and/or notions of what RSOs and streaks shapes can or should look like can be developed. Synthetic data can then be automatically generated with this limited number of labelled data and/or the notions of the shapes to bridge the gap to allow a neural net object classifier to classify streaks at a later time. To begin the automatic generation of synthetic data, a shape analysis technique (e.g., elastic shape analysis) can be used to analyze limited labelled data and/or the notions pf the shapes. The shape analysis technique can be used to perform streak object detection. For instance, the shape analysis technique can be used to extract features that define blob and streak pixels. A statistical mean technique (e.g., Karcher mean) can be used to an averaged version of features to be trained on. For instance, a Karcher mean technique can be used to determine how shapes can be averaged together, thereby facilitating the ability to identify average object-shape features that define a set of object-shapes. These averaged shapes will have similarities consistent with other members of the shape class. It is contemplated for the algorithm implementing Karcher mean technique to smooth shapes such that they are consistent with the other members of the class. This can be done to generate template(s) of shapes which conform to notions of what an object of interest should look like.

A Riemannian-manifold framework can be applied to a set of geodesics to identify and preserve properties that define a shape as it is altered in size, rotated, and/or translated. This can be done to model variations among detected shapes, quantify differences among shapes, and classify shapes by projecting a shape onto a manifold. For instance, the Riemannian-manifold framework can be configured as a metric that measures a combination of stretching and bending to optimally deform one curve into another. It is further contemplated to implement the Riemannian-manifold framework via a square root velocity function (SRVF) and a path straightening algorithm (PSA). The SRVF can quantify distances between two curves (e.g., a test curve and a reference curve), each curve being a curve on a perimeter of a shape. The PSA can be configured as an iterative optimization algorithm that uses gradient descent on the space of all continuous paths that begin at the SRVF. The PSA can be configured to find a minimum geodesic path between the test curve and the reference curve. The PSA can be configured to perform this iteratively, wherein the summation of iterations of a certain path length can be used to represent a PSA score. The PSA score can be used to determine how close the test curve is to the reference curve. For instance, the algorithm can be configured such that the smaller the PSA score, the more similar the test curve is to the reference curve. This PSA algorithm can be performed one or more times and for one or more test curves for a given reference curve. The result can be a classification of an object based on the shape. The classification can be used to generate labeled images using an averages representation of image classes as the synthetic ground-truthed dataset(s) for training purposes.

After the synthetic ground-truthed dataset(s) for training purpose synthetic ground-truthed dataset(s) for training purposes is/are created, the method for efficiently and dynamically classifying an object of an input image can continue by receiving an image of an area of interest captured by an image capture device 104. The method can involve scanning an image to identify a streak pattern. The method can involve comparing a streak pattern to one or more templates of a synthetic dataset to classify a streak pattern as being representative of a RSO, representative of a star, etc. The synthetic dataset can be composed of templates, wherein each template can be constructed of a statistical mean of shapes. The method can involve generating an output identifying a streak pattern as a resident space object or a star. As noted above, the statistical mean of shapes can include actual or expected (e.g., a notion of what constitutes an item of interest) shapes that conform to an item of interest, wherein at least one template can be constructed of a Karcher statistical mean of shapes. The method can involve identifying a streak pattern using a shape analysis technique (e.g., clastic shape analysis). The method can involve extracting features that define a blob pixel and/or a streak pixel via the shape analysis technique. The synthetic ground truth dataset can include labeled images of an averaged representation of image classes in which: a) objects from an image had been extracted via the shape analysis technique; and b) statistical data from pixels present in the extracted objects were used to generate an averaged representation of what constitutes a typical shape of an expected RSO. The shape analysis can be used to quantify a distance between a curve of a perimeter of the shape of interest of the object and a curve of a perimeter of a reference shape. The shape analysis can be used to measure a distance between the curve of the perimeter of the shape of interest of the object and the curve of the perimeter of the reference shape. For instance, the shape analysis can be used as used to quantify the distance by using a Square Root Velocity function, and measure the distance by using a Riemannian metric. In some embodiments, the shape analysis can involve use of a path straightening technique to determine that the shape of interest matched the reference shape.

### Examples

The following are exemplary systems, methods, and implementations of the embodiments disclosed herein. While the examples may focus on one implementation, it is understood that this is exemplary and the embodiments disclosed herein are not limited thereto.

Embodiments can address the challenge of producing an automated means of generating a huge ground-truthed dataset using a tiny input dataset as the image-generation foundation while requiring only the most basic computational resources. The examples describe in detail exemplary structures and sub-components that can be used to produce ground-truthed datasets.

Machine learning, when applied to object recognition, takes training data input, applies a model, and then makes distinctions between the classes of objects within the training set-which, in this exemplary case, are resident space objects or RSOs—and those objects who are not members of the training set. A machine learning model's theory of knowledge produces justified beliefs about the class of a particular RSO by means of using inference to generate a confidence interval deeming a candidate RSO to be a member of the training class. When this inference process works well, a true positive is generated where an RSO exists in the image under examination and its existence is detected and confirmed by the classifier. To get to a point where a machine learning model can make true positive inferences about the objects under examination within an image, a training set must be generated somehow.

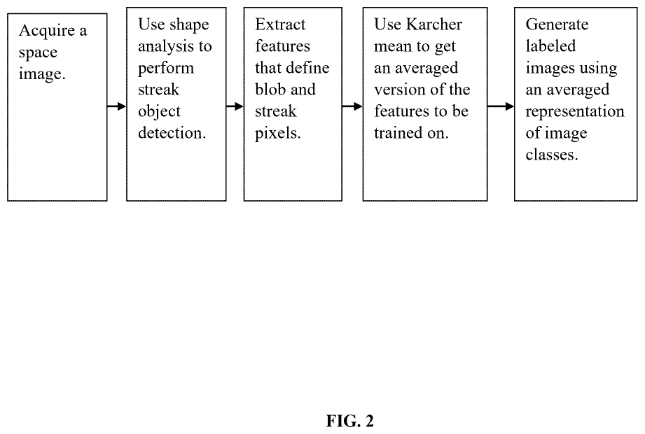

Space-centered training set can be difficult to produce because images under consideration are acquired in an arduous space-based environment. To overcome these challenging image acquisition circumstances, embodiments can utilize synthetic data generation to “bridge the gap” in the difference between what a neural net object classifier requires and the number of genuine space images available. The synthetic training images can be generated using the process in FIG. 2.

### Analysis for Object Detection

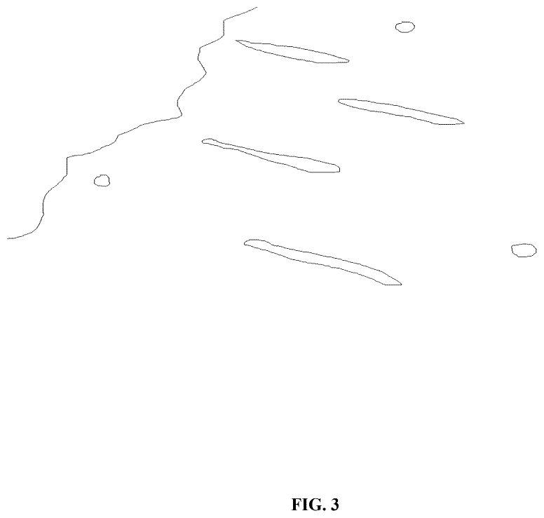

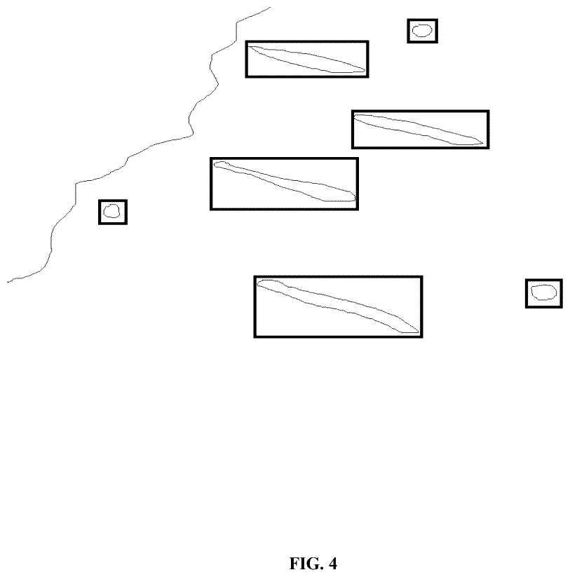

One problem associated with creating a synthetic dataset can be that the beginning point must be based on an understanding of the features that constitute an RSO that are of interest for classification. With embodiments disclosed herein, the foundation for extracting objects from an image need not rely upon neural nets. It is not plausible to use a neural net to generate a ground truth when no hand-labeled ground truth exists initially. Use of elastic shape analysis (ESA) can assist in this regard. ESA can allows for a direct inquiry into an image to find objects that conform to the shape of the object of which is being searching for. A typical RSO-containing image is illustrated in FIG. 3. An exemplary outcome of applying ESA to the image FIG. 3 is illustrated in FIG. 4.

### Shape Analysis Mathematical Overview

### Practical Applications of Manifolds Towards Shape Analysis

The practical application of manifolds for the engineering problems associated with pattern recognition and object classification is a topic of much research. The utilization of manifolds—in images specifically—is motivated by the idea of optimizing an objective function over a Euclidean space with the optimization solution being generated over a constrained set. In our case, this constrained set is defined as a family of closed contours representing respectively test and reference contours.

In practical terms, what this leads to is the development of a means of projecting high-dimensional data onto a much simpler structure and then being able to make predictions about this data's consistency with a similarly projected reference data. For our set of problems, this manifold-projection comparison methodology has the advantage of being lightweight in terms of training since only the reference data to be compared against need be stored. Furthermore, it has the advantage of being lightweight in terms of processor usage since it requires only the storage of a manifold projection and comparison algorithm rather than a large multi-layered network occupying multiple GPUs.

In our case, we are concerned with shape analysis as it applies to a human's hands' pose and their activity recognition. To achieve this goal, we must establish the following prerequisites:
1. Utilization of a suitable reference template
2. The ability to model variations among detected shapes.
3. Quantification of differences amongst shapes-which leads to
4. Performance of classification using shapes projected onto their respective manifolds.

The first requirement may be obtained via the construction of a template through a statistical mean (known as the Karcher mean) of shapes which conform to a notion of what constitutes an item of interest within the observed area of interest. The first requirement may also be met by simply constructing a target-like “carve out” or silhouette of the anticipated item of interest. In our case, we chose the latter option and, as we will see, even a general notion of what constitutes a hand form is sufficient for our pattern-classification/detection needs.

Broadly speaking, the remaining requirements can be achieved within a Riemannian-manifold framework as it is applied to a set of geodesics. Modeling the variations among shapes, quantifying their differences, and ultimately performing shape-based classifications starts first by preserving the intrinsic properties that define shape after it has been altered in size, rotated and/or translated. We will show in the next sections how the square root velocity function, the PSA and our APSA algorithm allow us to achieve these ends.

### The Square Root Velocity Function (SRVF) and Riemannian Manifolds for Shape Analysis

The SRVF was first introduced by Srivastava et al. The motivation behind this function is that it allows for the construction of an L² norm for the purpose of performing a quantification of distances between two curves which represent the perimeter of a given shape. What follows is a more formal definition of the nature of the SRVF taken from.

Let β be a parameterized curve (β:D→ [symbol] ) where D is the domain of parameterization. In our case, we are concerned with closed curves which simply means that the first element of β is equal to the last element in β. In our case, we assume that all members of D are strictly continuous, closed, and whose elements are within the set [0 1]. We define a mapping F: [symbol] according to F(ν)≡ν/\sqrt{∥ν∥} if ∥ν∥≠0 and 0 otherwise. Where ∥ν∥ is the Euclidean 2-norm in [symbol] and F is a continuous (closed) mapping. For our purposes of analyzing the shape of β, we will represent it using the SRVF defined as q:D→ [symbol] , where:

$$q ( t ) ≡ F ( β ( t ) ) = β ( t ) / \sqrt{‖ β ( t ) ‖}$$

Practically speaking, our first use of this function centers on the shape β—being defined as a sequence of tuples which constitute the x and y elements of an item-of-interest's perimeter within the area-of-interest examined—being converted into the SRVF representation q. This is the first step that enables the ability to compute a distance between the test curve β and the reference curve β. By using the SRVF, we can now ignore scale since every shape represented by the SRVF is placed within the set [0 1]. Furthermore, by placing the curves in the SRVF framework, we can perform calculations of the distances between curve β and the reference curve β by means of the L² norm.

The next ingredient needed is the elastic Riemannian metric—a metric that measures a combination of stretching and bending to optimally deform one curve into another. This metric is equal to the standard L² metric under the change of variable from β to q. Thus, it has been shown in [7] and [8] that the use of this metric constitutes the creation of a set of similarity-invariant metrics which can measure the differences (or distance) between similarly transformed curves.

Consider the set of all closed-shape spaces defined below as

$${S}_{c}^{2} = \{ q ∈ {L}^{2} ( [ 0 , 1 ] , {ℝ}^{2} ) \vert ‖ q ‖ = 1 , {\int }_{0}^{1} q ( t ) \vert q ( t ) \vert dt = 0 \}$$

The imposition of our Riemannian metric on this shape space thus completes that manifold's construction. The following definition serves as a good understanding of a geodesic and its significance: “A geodesic on a Riemannian manifold is defined as a shortest length path with respect to the chosen Riemannian metric between one point and another. Geodesic distance is defined as the length of such a path, and henceforth when we speak of a distance between shapes, we are referring to a geodesic on a manifold”.

We are concerned with the measurement of distances among closed curves βₜ and βᵣ where βₜ may have undergone diffeomorphic operations such as rotations, transpositions, or similarity-preserving elastic deformations. We are in fact concerned with performing an optimization over all such diffeomorphic operations such that we can calculate an approximate solution to the following optimization problem:

$${d}_{{S}_{c}^{∞}} = {lim}_{O ∈ SO , γ ∈ Γ} {d}_{{S}_{c}^{∞}} ( {q}_{r} , O ( {q}_{t} , γ ) )$$

where qₜ and qᵣ serve as the SRVF representations of βₜ and βᵣ respectively, O∈SO describe the operations on shapes such as rotations and translations and γ∈Γ serve as the elastic deformations performed on a shape. This calculation of the optimal transformations necessary to perform a comparison between two similar curves contained within the Riemannian manifolds such that we construct a minimizing geodesic and thus forms the basis of the path straightening algorithm.

### The Path-Straightening Algorithm

The PSA was first introduced by Srivastava et al. In summary, the path-straightening algorithm is an iterative optimization algorithm which operas by means of gradient descent on the space of all continuous paths that begin at the SRVF representation of qₜ and qᵣ. It is meant to find a minimizing geodesic path between qₜ and qᵣ. The summation of the path length serves as a PSA score and thus determines how “close” qₜ and qᵣ are from one another. The smaller the score, the more similar qₜ and qᵣ happen to be and thus a detection and classification can be performed.

We present the algorithmic steps that constitute the PSA. To streamline exposition, we do not explain the steps to a great level of detail but do provide references that an interested reader can pursue if necessary.
1. Given test and reference curves βₜ and β_{y}, compute their representations qₜ and qᵣ in

$${S}_{c}^{∞} .$$

2. Initialize a geodesic path α between qₜ and qᵣ in

$${S}_{c}^{∞}$$

and project each point along it in

$${S}_{c}^{∞}$$

using step 1.
3. Compute the velocity vector field dα/dτ along the path α using the algorithm defined in [1]
4. Compute the covariant integral of dα/dτ, denoted by u, using the algorithm defined in [1]
5. Compute the backward parallel transport of the vector along u(1) using the algorithm denote it by ũ.
6. Compute the full gradient vector field of the energy E along the path α, denoted by w, using w(τ)=u(τ)−τũ(τ) by means of the algorithm defined in.
7. Update α along the vector field w using the algorithm defined in. If

$${\sum }_{τ = 1}^{w} 〈 w ( τ ) , w ( τ ) 〉$$

small, then stop. Else, return to step 3.
8. Compute the path length along α and report this as the scoring distance between qₜ and qᵣ.
   Extracting Numerical Features that Define an Object

Once we have detected and identified the streaks and/or blobs which comprise our RSOs within our sample space imagery, our next task is to discover the intrinsic numerical qualities that define the pixels comprising these streaks/blobs. The properties we are concerned about are the RSO pixels' mean, median, and standard deviation within its grayscale color map. Equipped with this knowledge, we now have the ability to add further object realism to the streaks we intend to generate.

### The Karcher Mean for Object Generation

The Karcher mean (KM) refers to a method for finding how shapes can be “averaged” together. In our case, we are interested in how the KM allows us to understand the average RSO-shape features that define an RSO's shape feature set. Using this shape-oriented knowledge, the synthetic dataset's RSOs are representative of what can be expected in a genuine space-based dataset.

The calculation of the KM uses the same mathematical tools used in the context of calculating the outcome of the PSA. In a manner similar to that of calculating the PSA mentioned above, the KM relies upon resolving the outcome of an optimization algorithm such that the minimum distance is found amongst the prospective shapes that occupy a given class. The point is to find a minimizing geodesic such that a path distance is minimized between a reference chosen from a class and all other candidate members within that class.

What this means in actual practice is that the averaged shapes produced will have similarities consistent with other members of the shape class. Wildly different shapes may be incorporated into the KM, and the algorithm will attempt to “smooth” out these different shapes such that they are consistent with the other members of the class. Note that we are interested in what defines the “essentials” in a given shape class-hence the fine details that mark a streak are made irrelevant because they are smoothed away.

The optimization formula that we use to perform the KM [μ] is given below:

$$[ μ ] = {argmin}_{[ q ] ∈ S} {\sum }_{i = 1}^{n} {{d}_{S} ( [ q ] , [ {q}_{i} ] )}^{2}$$

This formula indicates that we want to compute the minimum sum of the square geodesic distances between two prospective members [q] and [qᵢ] in shape class Q found in shape space S.

The algorithm used for computing the Karcher mean for a given shape class is given below [9]:
1. Let q̅₀ be an initial estimate of the Karcher mean and set j=0.
2. For each i=1, . . . , n, compute

$${v}_{i} = {exp}_{{\overline{q}}_{j}}^{- 1} ( {q}_{i} ) .$$

3. Compute the average direction

$$\overline{v} = \frac{1}{n} {\sum }_{i = 1}^{n} {v}_{i} .$$

4. If ∥ν̅∥ is small, then stop. Else, update using q̅ⱼ₊₁=exp_{q̅}_{ⱼ}(εν̅), ε>0 small.
5. Set j=j+1 and return to Step 1.

### Constructing a Synthetic Ground Truth Dataset Using Minimal Resources

As we stated above, our challenge now is to make sure we can generate credible synthetic RSO data for the purpose of training a neural net-based object detector/classifier. With the above-named components in place, this challenge can be addressed in a straightforward manner. Our process of creating a synthetic dataset is addressed through the following steps.
1. Get parameters for image size, number of images to produce and the max/min number of streaks and blobs to appear in synthetic images.
2. For each synthetic image to be produced
   2.1. Create a baseline dark image of a size prescribed in step 1.
   2.2. Optionally add gaussian noise to our image.
   2.3. For each RSO to be produced
      2.3.1. Get RSO size and rotation by selecting from a random distribution whose bounds are selected by the user.
      2.3.2. Get expected RSO pixel brightness values and their distribution within the RSO; these bounds are selected by the user.
      2.3.3. Place KM-averaged RSO with the above-defined properties on an image mask.
   2.4. Save image in prescribed location.

Step 1 is contained in a text file and indicates the parameters necessary for the remainder of the code to continue. The for loop in step 2 is concerned with overseeing the images produced. Step 2.1 creates a baseline dark image which is nothing more than a matrix of zeros. Step 2.2 uses an image noise generator as a means of optionally adding image corruption to the training images being produced. Step 2.3 dives into the particulars of the synthetic RSOs added to our (possibly corrupted) image. Step 2.3.1 gets the RSO's size and rotation (these properties are selected from a random distribution whose bounds are selected by the user). Step 2.3.2 the expected RSO would have a pixel brightness and the distribution of these pixels picked from a random distribution whose boundaries are set by the user. Step 2.3.3 places the KM-averaged shape with the pixel properties obtained earlier. Finally, the RSO-populated image is saved.

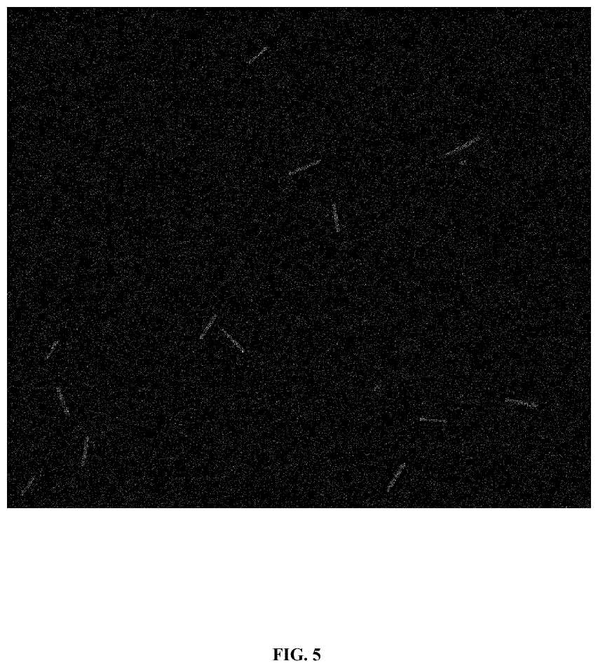

The results of our synthetic dataset generation are provided in FIG. 5. FIG. 5 shows an exemplary flow diagram for generating a synthetic training image.

The current prevailing state of the art in this area of training set generation called satsim. Our method for generating synthetic data is different in the sense that we are not reliant upon graphics processing units (GPUs) or large training datasets. All we require is a standard laptop's processing ability and only one training image to gain an understanding of what constitutes an RSO. Furthermore, we do not require a lengthy training period for the generative AI used by satsim; we only need set the parameters mentioned above before executing the training set production.

This resource-light means of generating ground-truthed imagery for training purposes represents a means of producing training sets with relatively minimal computational effort. Thus, we can adapt our training sets quickly in the face of new types of RSOs and/or environmental conditions under which the imagery is obtained. By making this method of producing training sets available to those who are interested in performing computer vision in space, interested people can perform their labeling and training work more efficiently with little additional effort.

### REFERENCES

The following references are incorporated by reference in their entireties.
[1] A Srivastava, E. Klassen, S. Joshi, and I Jermym, “Shape analysis of elastic curves in Euclidean spaces”, IEEE Transactions on Pattern Analysis and Machine Intelligence, vol. 33(7), pp. 1415-1428 July 2011.
[2] A. Srivastava, X. Guo, H. Laga, “Advances in geometrical analysis of topologically-varying shapes”, Proc of the 2020 IEEE 17^{th} International Symposium on Biomedical Imaging Workshops, Iowa City, IA, April 2020.
[3] S. Lohit and P. Turaga, “Learning invariant Riemannian geometric representations using deep nets,” in Proc. Of International Conference on Computer Vision Workshop (ICCVW), Venice, October 2017.
[4] M. Ali, “Statistical learning over manifolds and its applications in computer vision”, Ph.D. dissertation, College of Computing and Mathematics, Charles Sturt University, Bathurst, 2018.
[5] A Srivastava, P Turaga, and S. Kurtek. On Advances in Geometric Approaches for 2D and 3D Shape Analysis and Activity Recognition, Journal of Image and Vision Computing 30 (6), June 2012.
[6] W. Huang, Y. You, K. Gallivan, P.-A. Absil, Karcher Mean in Elastic Shape Analysis, Proc of the 1^{st} Int'l Workshop on DIFFerential Geometry in Computer Vision for Analysis of Shapes, Images, and Trajectories (DIFF-CV 2015), pp 2.1-2.11, 2015.
[7] D. T. Robinson, “Functional data analysis and partial shape matching in the square root velocity framework”, Ph.D. dissertation, Dept. of Statistics, Florida State University, Tallahassee, 2012.
[8] D. W. Bryner, “2D affine and projective shape analysis, and Bayesian elastic active contours”, Ph.D. dissertation, Dept. of Statistics, Florida State University, Tallahassee, 2013.
[9] S. Kurtek, “Riemannian Shape Analysis of Curves and Surfaces”, Ph.D. dissertation, Dept. of Statistics, Florida State University, Tallahassee, 2012.
[10] Satsim GitHub—ssc-ai/satsim: SatNet annotated image simulator using Tensorflow.

It will be understood that modifications to the embodiments disclosed herein can be made to meet a particular set of design criteria. For instance, any of the components, features, or steps of the system, apparatus, or method can be any suitable number or type of each to meet a particular objective. Therefore, while certain exemplary embodiments of the systems and methods disclosed herein have been discussed and illustrated, it is to be distinctly understood that the invention is not limited thereto but can be otherwise variously embodied and practiced within the scope of the following claims.

It will be appreciated that some components, features, and/or configurations can be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiments. Thus, the components, features, and/or configurations of the various embodiments can be combined in any manner and such combinations are expressly contemplated and disclosed by this statement.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning, range, and equivalence thereof are intended to be embraced therein. Additionally, the disclosure of a range of values is a disclosure of every numerical value within that range, including the end points.

What is claimed is:

1. A system for efficiently and dynamically classifying an object of an input image, the system comprising:
an input module for receiving an image of an area of interest captured by an image capture device;
a memory including a synthetic dataset composed of templates, each template constructed of a statistical mean of shapes;
a processor including a detection module and a classifier module, wherein:
the detection module is configured to scan an image to identify a streak pattern; and
the classifier module is configured to compare a streak pattern from the detection module and access one or more templates from the memory to classify a streak pattern as being representative of a resident space object or representative of a star; and
a user interface configured to generate an output identifying a streak pattern as a resident space object or a star.

2. The system of claim 1, wherein
the statistical mean of shapes includes actual or expected shapes that conform to an item of interest.

3. The system of claim 1, wherein:
at least one template is constructed of a Karcher statistical mean of shapes.

4. The system of claim 1, wherein:
the detection module is configured to identify a streak pattern using a shape analysis technique.

5. The system of claim 4, wherein:
the shape analysis technique includes elastic shape analysis.

6. The system of claim 5, wherein:
the detection module is configured to extract features that define a blob pixel and/or a streak pixel via elastic shape analysis.

7. The system of claim 1, wherein
the synthetic ground truth dataset includes labeled images of an averaged representation of image classes in which:
objects from an image had been extracted via elastic shape analysis; and
statistical data from pixels present in the extracted objects were used to generate an averaged representation of what constitutes a typical shape of an expected resident space object.

8. The system of claim 7, wherein the elastic shape analysis:
was used to quantify a distance between a curve of a perimeter of the shape of interest of the object and a curve of a perimeter of a reference shape; and
was used to measure a distance between the curve of the perimeter of the shape of interest of the object and the curve of the perimeter of the reference shape.

9. The system of claim 8, wherein the elastic shape analysis:
was used to quantify the distance by using a Square Root Velocity function; and
was used to measure the distance by using a Riemannian metric.

10. The system of claim 7, wherein:
the elastic shape analysis involved use of a path straightening technique to determine that the shape of interest matched the reference shape.

11. A method for efficiently and dynamically classifying an object of an input image, the method comprising:
receiving an image of an area of interest captured by an image capture device;
scanning an image to identify a streak pattern;
comparing a streak pattern to one or more templates of a synthetic dataset to classify a streak pattern as being representative of a resident space object or representative of a star, the synthetic dataset being composed of templates, wherein each template is constructed of a statistical mean of shapes; and
generating an output identifying a streak pattern as a resident space object or a star.

12. The method of claim 11, wherein
the statistical mean of shapes includes actual or expected shapes that conform to an item of interest.

13. The method of claim 11, wherein:
at least one template is constructed of a Karcher statistical mean of shapes.

14. The method of claim 11, comprising:
identifying a streak pattern using a shape analysis technique.

15. The method of claim 14, wherein:
the shape analysis technique includes elastic shape analysis.

16. The method of claim 15, comprising:
extracting features that define a blob pixel and/or a streak pixel via elastic shape analysis.

17. The method of claim 11, wherein:
the synthetic ground truth dataset includes labeled images of an averaged representation of image classes in which:
objects from an image had been extracted via elastic shape analysis; and
statistical data from pixels present in the extracted objects were used to generate an averaged representation of what constitutes a typical shape of an expected resident space object.

18. The method of claim 17, wherein the elastic shape analysis:
was used to quantify a distance between a curve of a perimeter of the shape of interest of the object and a curve of a perimeter of a reference shape; and
was used to measure a distance between the curve of the perimeter of the shape of interest of the object and the curve of the perimeter of the reference shape.

19. The method of claim 18, wherein the elastic shape analysis:
was used to quantify the distance by using a Square Root Velocity function; and
was used to measure the distance by using a Riemannian metric.

20. The method of claim 18, wherein:
the elastic shape analysis involved use of a path straightening technique to determine that the shape of interest matched the reference shape.
